(19) United States
(12) Patent Application Publication
(10) Pub. No.: US 2005/0206961 A1
(43) Pub. Date: Sep. 22, 2005

(54) Image processing apparatus and image processing method

(75) Inventors: Haruko Kawakami, Mishima-shi (JP); Naofumi Yamamoto, Kawasaki-shi (JP)

Correspondence Address: FOLEY AND LARDNER;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 10/801,715

(22) Filed: Mar. 17, 2004

(51) Int. Cl. G06K 15/00

(52) U.S. Cl. 358/448; 358/2.1

(57) ABSTRACT

When any one of a character/photo mode, a character mode, a photo mode, a print mode and a map mode is selected, an image processing section 103 in an image processing apparatus 1 performs an image process by allocating a usable memory capacity of a RAM 105 to a color conversion process, a discrimination process, a filter process and a tone process, which are included in an image process, in accordance with the selected mode. In this case, the image processing section 103 also allocates a processing time to the respective processes in accordance with the selected mode.

### BACKGROUND OF THE INVENTION

1. Field of the Invention

The present invention relates to an image processing apparatus such as a copying machine, which processes an input image, and an image processing method.

2. Description of the Related Art

In a well-known technique for use in a conventional copying machine, the content of processing, such as a color conversion process, a filter process and a tone process, is switched according to a mode that is designated through a control panel. When such a mode-by-mode switch of processing is performed in the conventional apparatus, the memory capacity and processing time, which are used in the process sections including a color conversion process section and a tone process section, need to be maximized in order to obtain a desirable image in all modes.

As stated above, in order to support all modes which are selectable in the conventional configuration, both the memory capacity and the processing time for use in the processing in each process section need to be set at maximum values. Consequently, the scale of hardware is considerably increased. Otherwise, in order to restrict the scale of hardware, the performance in any one of the modes or the quality of an output image, which is obtained in such a mode, has to be sacrificed.

### BRIEF SUMMARY OF THE INVENTION

The object of an aspect of the present invention is to provide an image processing apparatus and an image processing method, which can perform image processing with high quality in each of modes with minimum necessary memory capacity and processing time.

According to an aspect of the present invention, there is provided an image processing apparatus comprising: input means for inputting an image signal; image processing means for subjecting the image signal input from the input means to an image process comprising a plurality of processes; memory means for use in the image process in the image processing means; designation means for designating a process condition for the image signal input by the input means; and control means for effecting a control to allocate a memory capacity, which is usable in the memory means, to the individual processes in the image process in accordance with the process condition designated by the designation means.

According to another aspect of the present invention, there is provided an image processing method comprising: inputting an image signal; subjecting the input image signal to an image process comprising a plurality of processes with use of memory means; designating a process condition for the input image signal; and allocating a memory capacity, which is usable in the memory means, to the individual processes in the image process in accordance with the designated process condition.

Additional objects and advantages of an aspect of the invention will be set forth in the description which follows, and in part will be obvious from the description, or may be learned by practice of the invention. The objects and advantages of an aspect of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the embodiments given below, serve to explain the principles of an aspect of the invention.

FIG. 1 is a block diagram schematically showing the structure of an image processing apparatus according to the present invention;

FIG. 2 shows an example of a display screen on a control panel;

FIG. 3 is a view for explaining the memory content and processing time in a character/photo mode;

FIG. 4 is a view for explaining the memory content and processing time in a photo mode;

FIG. 5 is a view for explaining the memory content and processing time in a character mode;

FIG. 6 is a view for explaining the memory content and processing time in a map mode; and

FIG. 7 is a block diagram schematically showing the structure of an image processing apparatus according to a fourth embodiment of the invention.

### DETAILED DESCRIPTION OF THE INVENTION

Embodiments of the present invention will now be described with reference to the accompanying drawings.

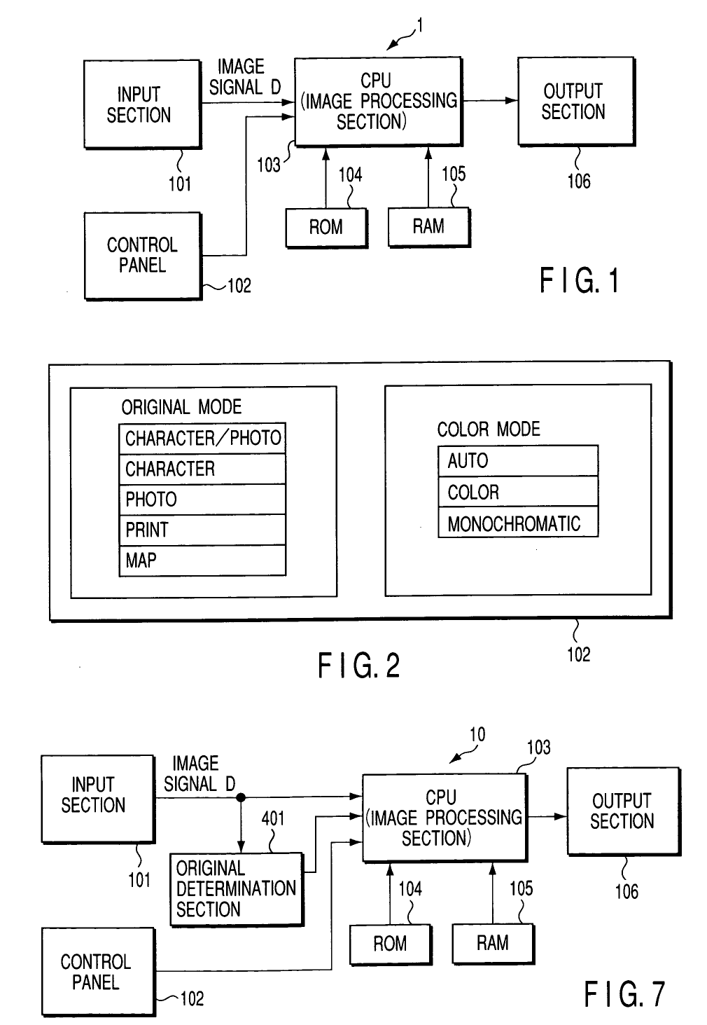

FIG. 1 schematically shows the structure of an image processing apparatus 1 according to the present invention. The image processing apparatus 1 includes an input section 101, a control panel 102, a CPU (image processing section) 103, a ROM 104, a RAM 105 and an output section 106.

In FIG. 1, to start with, an image signal D is produced from the input section 101. A fixed reading time is set in the input section 101. The processing time is restricted by the reading time. In the case of a color image, the image signal D comprises RED, GREEN and BLUE signals, which have been passed through a color separation filter. The image signal D, when it is a monochromatic signal, has a single value that is representative of luminance.

On the other hand, a desired mode process, which is associated with the input image, is designated through the control panel 102. The image signal D and the signal representative of the mode designated through the control panel 102 are supplied to the image processing section 103. The read-only memory ROM 104 and the random access memory RAM 105 are connected to the image processing section 103. The image processing section 103, as will be described later in greater detail, adjusts the operation of write to the RAM 105 in accordance with the designated mode. The image processing section 103 performs the image processing and delivers an output to the output section 106.

The image processing section 103 effects adjustment so as to execute the image process corresponding to designated mode.

FIG. 2 shows an example of a display screen on the control panel 102. As is shown in FIG. 2, the kind of an original, the color mode of an original, etc. can be selected through the control panel 102. In the present embodiment, as shown in FIG. 2, one of a character/photo mode, a character mode, a photo mode, a print mode and a map mode is selectable. On the other hand, color modes include at least two modes: “COLOR” and “MONOCHROMATIC”. The color modes in this embodiment include “AUTO”, “COLOR” and “MONOCHROMATIC”, as shown in FIG. 2, and one of them is selectable. When “AUTO” is selected, it is automatically determined whether the original is a color original or a monochromatic original.

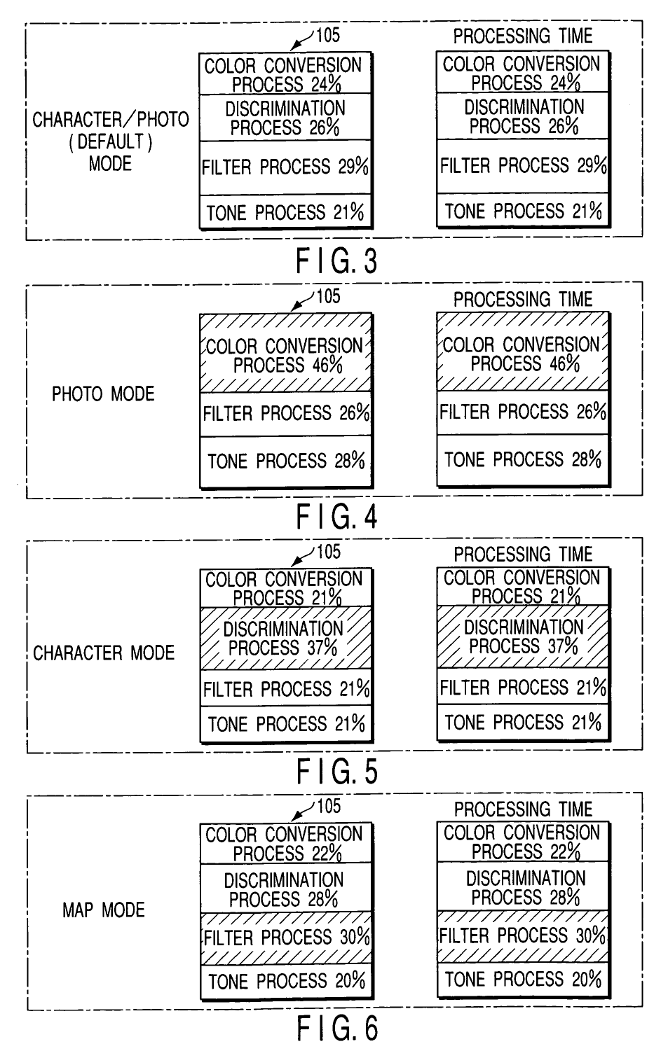

Referring now to FIG. 3 to FIG. 6, a description will be given of image processes that are associated with respective modes and are performed by the image processing section 103 according to a first embodiment of the invention having the above-described structure.

FIG. 3 is a conceptual view that illustrates an image process in a case where the character/photo mode is selected through the control panel 102. In the character/photo mode, balancing is performed between a color conversion process, a discrimination process, a filter process and a tone process. When the character/photo mode is selected, the image processing section 103 performs the image process by allocating, as shown in FIG. 3, the memory capacity of the RAM 105 for the image process in the following fashion: color conversion process=24%, discrimination process=26%, filter process=29% and tone process 21%. The processing time is also allocated, as shown in FIG. 3, in the following fashion: color conversion process=24%, discrimination process=26%, filter process=29% and tone process 21%.

FIG. 4 is a conceptual view that illustrates an image process in a case where the photo mode is selected through the control panel 102. In the photo mode, extraction of a character is needless. Hence, without performing discrimination, the memory capacity and processing time are allocated with a stress on the color conversion so as to achieve good color reproduction. When the photo mode is selected, the image processing section 103 performs the image process by allocating, as shown in FIG. 4, the memory capacity of the RAM 105 for the image process in the following fashion: color conversion process (indicated by hatching)=46%, filter process=26% and tone process 28%. The processing time is also allocated, as shown in FIG. 4, in the following fashion: color conversion process (indicated by hatching)=46%, filter process=26% and tone process 28%.

FIG. 5 is a conceptual view that illustrates an image process in a case where the character mode is selected through the control panel 102. In the character mode, extraction of a character is more important than color reproduction. Hence, a reference region for use in character discrimination is enlarged, and the memory capacity and processing time for the character discrimination are increased accordingly. When the character mode is selected, the image processing section 103 performs the image process by allocating, as shown in FIG. 5, the memory capacity of the RAM 105 for the image process in the following fashion: color conversion process=21%, discrimination process (indicated by hatching)=37%, filter process=21% and tone process 21%. The processing time is also allocated, as shown in FIG. 5, in the following fashion: color conversion process=21%, discrimination process (indicated by hatching)=37%, filter process=21% and tone process 21%.

FIG. 6 is a conceptual view that illustrates an image process in a case where the map mode is selected through the control panel 102. In the map mode, the memory capacity and processing time are allocated with a stress on the filter process. When the map mode is selected, the image processing section 103 performs the image process by allocating, as shown in FIG. 6, the memory capacity of the RAM 105 for the image process in the following fashion: color conversion process=22%, discrimination process=28%, filter process (indicated by hatching)=30% and tone process 20%. The processing time is also allocated, as shown in FIG. 6, in the following fashion: color conversion process=22%, discrimination process=28%, filter process (indicated by hatching)=30% and tone process 20%.

On the other hand, when the color mode is set at “AUTO” on the control panel shown in FIG. 2, the image processing section 103 executes selection as to whether the original is “COLOR” or “MONOCHROMATIC”. If the “COLOR” is selected, the ratio of allocation to the color conversion process is increased. If “MONOCHROMATIC” is selected, the ratio of allocation to the tone process is increased.

The processing time and memory capacity are allocated in combination with the designation of the above-described original mode, and also the total memory capacity and the total processing time for the image process are adjusted.

As has been described above, according to the first embodiment, even where the reading time and transmission time in the input section are limited to fixed values, the allocation of memory capacity and processing time for the respective image processes are adjusted in accordance with the kind and color mode of the original to be processed. Thereby, a more suitable image process for each original can be executed. Hence, unlike the prior art, there is no need to provide an enormous memory capacity and processing time so as to support all kinds of originals. A desired image process can be performed with a minimum necessary circuitry scale and processing time.

A second embodiment of the invention will now be described.

Assume that the processing time in the output section is restricted to a predetermined value, as in the case of electrophotography (e.g. in offices) when the structure of the image processing apparatus shown in FIG. 1 is used. In such a case, the image processing section 103 similarly performs a suitable image process for the designated original mode and color mode by properly assigning the memory capacity of the RAM 105 and the processing time within the restricted processing time in the output section in accordance with the original mode and color mode.

As has been described above, according to the second embodiment, even where the processing time is restricted as in the case of electrophotography, it is possible to execute the proper process in accordance with the selected original mode or color mode.

A third embodiment of the invention will now be described.

In the case of an ink jet printer, as a matter of course, there is no restriction to the processing time in the output section (e.g. in homes) when the structure of the image processing apparatus shown in FIG. 1 is used. In such a case, the image processing section 103 changes the allocation of the memory capacity of the RAM 105 for the selected original mode or color mode. Thereby, the required memory capacity is limited to a minimum.

Even where there is no restriction to the time, the time allocation is changed in accordance with the selected mode. Thereby, unnecessary time is not allocated to the respective processes. Therefore, the processing time is shortened and the printing speed is increased.

A fourth embodiment of the invention will now be described.

FIG. 7 schematically shows the structure of an image processing apparatus 10 according to the fourth embodiment of the invention. The image processing apparatus 10 includes an input section 101, a control panel 102, a CPU (image processing section) 103, a ROM 104, a RAM 105, an output section 106 and an original determination section 401. The parts common to those already described are denoted by like reference numerals, and a description is omitted. In this structure, the original determination section 401 is provided. The original determination section 401 examines, for example, the cyclic structure of the original, and determines the presence/absence of a halftone screen, the presence/absence of a character, etc. Thus, the original determination section 401 determines the kind of the original.

In the fourth embodiment, the kind of the original is automatically determined, and an image process suitable for the original is executed.

Assume that in FIG. 7 the original mode and color mode are designated on the control panel 102 or are set by default.

An image signal D is delivered from the input section 101 to the image processing section 103 as well as to the original determination section 401. The original determination section 401 examines, for example, the cyclic structure of the original, and determines the presence/absence of a halftone screen, the presence/absence of a character, etc. Thus, the original determination section 401 determines the kind of the original. The determination result of the original determination section 401 is output to the image processing section 103.

In accordance with the determination result from the original determination section 401, the image processing section 103 adjusts the allocation of the memory capacity of the RAM 105 that is used, and the allocation of the processing time.

When “AUTO” is selected as the color mode on the control panel 102, or “AUTO” is set by default without specific selection, the original determination section 401 determines that an image to be processed is a monochromatic one, if the input image signal D is not a single signal but comprises color signals and the number of dots, which can be regarded as having chromatic colors, is within a predetermined range. Otherwise, the original determination section 401 determines that the image to be processed is a color one. Color difference signals between RED and GREEN and between GREEN and BLUE are found with respect to the color signals. If the absolute value of each of the R-G signals and G-B signal or the sum of squares of both is greater than a predetermined threshold, a chromatic color is determined.

The determination result is delivered to the image processing section 103 to allocate the memory capacity of the RAM 105 for, e.g. the color conversion process and tone process and to allocate the processing time, as well as to adjust the total capacity of the memory used and the total processing time.

As has been described above, according to the fourth embodiment, even where the user is unfamiliar with the method of designating the kind of original, or even where an original with different attributes is present among other originals, a proper-process can be executed for the original.

A fifth embodiment of the invention will now be described.

In the present invention, in addition to the preceding embodiments, a special process that is not normally used can be added, in accordance with the condition of the original, to the image process functions that are set by default when the above-described structure is used.

Assume, for example, that the original determination section 401 determines that an image to be processed contains additional information other than image data. In such a case, the image processing section 103 executes a special additional process to add extracted information, thereby to prevent degradation in the additional information. Thus, the image processing section 103 changes the allocation of the memory capacity of the RAM 105 and the allocation of the processing time for the image process.

As has been described above, according to the fifth embodiment of the invention, when an original that requires a special additional process is input, a proper image process can be executed.

According to the above-described embodiments, unlike the prior-art image processing, there is no need to provide an enormous memory capacity and processing time for obtaining high-quality output images in respective modes. With a minimum necessary memory capacity and processing time, a high-quality output image can be obtained in each mode.

Moreover, with a minimum memory capacity and processing time, a proper image process can be executed.

A special process, which is not normally used, can be added, and ordinary image processes can efficiently be executed.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An image processing apparatus comprising:
input means for inputting an image signal;
image processing means for subjecting the image signal input from the input means to an image process comprising a plurality of processes;
memory means for use in the image process in the image processing means;
designation means for designating a process condition for the image signal input by the input means; and
control means for effecting a control to allocate a memory capacity, which is usable in the memory means, to the individual processes in the image process in accordance with the process condition designated by the designation means.

2. The image processing apparatus according to claim 1, wherein the process condition designated by the designation means comprises a character/photo mode, a photo mode with a stress on reproducibility of a photo, a character mode with a stress on reproducibility of a character, and a map mode.

3. The image processing apparatus according to claim 1, wherein the process condition designated by the designation means comprises an auto mode in which it is determined whether the input image signal is a color signal or a monochromatic signal, a color mode in which a color image process is executed, and a monochromatic mode in which a monochromatic image process is executed.

4. The image processing apparatus according to claim 1, wherein said plurality of processes comprise a color conversion process, a discrimination process, a filter process and a tone process.

5. The image processing apparatus according to claim 1, wherein the control means differently allocates a processing time to the individual processes in the image process in accordance with the process condition designated by the designation means.

6. The image processing apparatus according to claim 1, wherein in a case where a processing time in the image process is restricted, the control means allocates a memory capacity to the individual processes in the image process in accordance with the process condition designated by the designation means.

7. The image processing apparatus according to claim 1, wherein in a case where a processing time in the image process is restricted, the control means differently allocates the processing time to the individual processes in the image process in accordance with the process condition designated by the designation means.

8. The image processing apparatus according to claim 1, wherein in a case where the process condition designated by the designation means is a photo mode, the control means allocates a greater memory capacity of the memory means, or a greater processing time, or a greater memory capacity and a greater processing time to a color conversion process in the image process than to the other processes in accordance with the photo mode.

9. The image processing apparatus according to claim 1, wherein in a case where the process condition designated by the designation means is a photo mode, the control means allocates a less memory capacity of the memory means, or a less processing time, or a less memory capacity and a less processing time to a discrimination process in the image process than to the other processes in accordance with the photo mode, or the control means allocates neither a memory capacity of the memory means nor a processing time to the discrimination process.

10. The image processing apparatus according to claim 1, wherein in a case where the process condition designated by the designation means is a character mode, the control means allocates a greater memory capacity of the memory means, or a greater processing time, or a greater memory capacity and a greater processing time to a discrimination process in the image process than to the other processes in accordance with the character mode.

11. The image processing apparatus according to claim 1, wherein in a case where the process condition designated by the designation means is a map mode, the control means allocates a greater memory capacity of the memory means, or a greater processing time, or a greater memory capacity and a greater processing time to a filter process in the image process than to the other processes in accordance with the map mode.

12. The image processing apparatus according to claim 1, wherein in a case where an additional process that is different from the processes in the image process is newly provided, the control means effects a control to allocate a memory capacity, which is usable in the memory means, to the individual processes of the image process and to the additional process in accordance with the process condition designated by the designation means.

13. The image processing apparatus according to claim 1, wherein in a case where an additional process that is different from the processes in the image process is newly provided, the control means differently allocates a processing time to the individual processes of the image process and to the additional process in accordance with the process condition designated by the designation means.

14. An image processing apparatus comprising:
input means for inputting an image signal;
image processing means for subjecting the image signal input from the input means to an image process comprising a plurality of processes;
memory means for use in the image process in the image processing means;
determination means for determining attributes of the image signal input from the input means;
designation means for designating a process condition for the image signal input by the input means; and
control means for effecting a control to allocate a memory capacity, which is usable in the memory means, to the individual processes in the image process in accordance with the process condition designated by the designation means or a determination result of the determination means.

15. The image processing apparatus according to claim 14, wherein the control means differently allocates a processing time to the individual processes in the image process in accordance with the process condition designated by the designation means or the determination result of the determination means.

16. An image processing method comprising:
inputting an image signal;
subjecting the input image signal to an image process comprising a plurality of processes with use of memory means;
designating a process condition for the input image signal; and
allocating a memory capacity, which is usable in the memory means, to the individual processes in the image process in accordance with the designated process condition.

17. The image processing method according to claim 16, wherein a processing time is differently allocated to the individual processes in the image process in accordance with the designated process condition.

18. The image processing apparatus according to claim 2, wherein in a case where the process condition designated by the designation means is a photo mode, the control means allocates a greater memory capacity of the memory means, or a greater processing time, or a greater memory capacity and a greater processing time to a color conversion process in the image process than to the other processes in accordance with the photo mode.

19. The image processing apparatus according to claim 2, wherein in a case where the process condition designated by the designation means is a photo mode, the control means allocates a less memory capacity of the memory means, or a less processing time, or a less memory capacity and a less processing time to a discrimination process in the image process than to the other processes in accordance with the photo mode, or the control means allocates neither a memory capacity of the memory means nor a processing time to the discrimination process.

20. The image processing apparatus according to claim 2, wherein in a case where the process condition designated by the designation means is a character mode, the control means allocates a greater memory capacity of the memory means, or a greater processing time, or a greater memory capacity and a greater processing time to a discrimination process in the image process than to the other processes in accordance with the character mode.
